(19) United States
(12) Patent Application Publication
(10) Pub. No.: US 2018/0080725 A1
(43) Pub. Date: Mar. 22, 2018

(54) Baseboard Heater Radiator Cover

(71) Applicant: Greative Hydronics International, Sagamore Beach, MA (US)

(72) Inventors: Craig M. Coe, Sagamore Beach, MA (US); Robert Greene, Bourne, MA (US); Philip David Haglof, Sagamore Beach, MA (US); Maria Elena Coe, Sagamore Beach, MA (US)

(73) Assignee: Creative Hydronics International, Sagamore Beach, MA (US)

(21) Appl. No.: 15/823,004

(22) Filed: Nov. 27, 2017

Related U.S. Application Data
(63) Continuation of application No. 13/227,259, filed on Sep. 7, 2011.
(60) Provisional application No. 61/380,989, filed on Sep. 8, 2010.

(51) Int. Cl. F28F 21/06; F28F 9/00; F24D 19/06; B29C 47/00; B29C 51/00; F28D 21/00

(52) U.S. Cl. CPC F28F 21/061; F28F 9/001; F24D 19/06; F24D 2220/2072; B29C 51/00; F28D 2021/0035; B29C 47/0009

(57) ABSTRACT

A radiator heater cover includes a cover formed of thermoplastic in a shape that fits over at least a portion of a radiator heater. The radiator heater cover defines a plurality of apertures in at least a portion of an outer surface of the cover that are dimensioned and spaced to provide desired convective heat transfer away from predetermined areas of the radiator heater.

### RELATED APPLICATION SECTION

The present application is a non-provisional of copending U.S. Provisional Patent Application Ser. No. 61/380,989, filed Sep. 8, 2010, and entitled “Baseboard Heat Radiator Cover.” The entire content of U.S. Patent Application Ser. No. 61/380,989 is incorporated herein by reference.

The section headings used herein are for organizational purposes only and should not to be construed as limiting the subject matter described in the present application in any way.

### BRIEF DESCRIPTION OF THE DRAWINGS

The present teaching, in accordance with preferred and exemplary embodiments, together with further advantages thereof, is more particularly described in the following detailed description, taken in conjunction with the accompanying drawings. The skilled person in the art will understand that the drawings, described below, are for illustration purposes only. The drawings are not necessarily to scale, emphasis instead generally being placed upon illustrating principles of the teaching. The drawings are not intended to limit the scope of the Applicants' teaching in any way.

FIG. 1 illustrates a perspective view of the front panel of a radiator heater cover according to the present teaching that provides convective heat transfer from a radiator heater into a room.

FIG. 2 illustrates a side view of a radiator heater cover according to the present teaching that provides convective heat transfer from a radiator heater into a room.

DESCRIPTION OF VARIOUS EMBODIMENTS

Reference in the specification to “one embodiment” or “an embodiment” means that a particular feature, structure, or characteristic described in connection with the embodiment is included in at least one embodiment of the teaching. The appearances of the phrase “in one embodiment” in various places in the specification are not necessarily all referring to the same embodiment.

It should be understood that the individual steps of the methods of the present teachings may be performed in any order and/or simultaneously as long as the teaching remains operable. Furthermore, it should be understood that the apparatus and methods of the present teachings can include any number or all of the described embodiments as long as the teaching remains operable.

The present teaching will now be described in more detail with reference to exemplary embodiments thereof as shown in the accompanying drawings. While the present teaching is described in conjunction with various embodiments and examples, it is not intended that the present teaching be limited to such embodiments. On the contrary, the present teaching encompasses various alternatives, modifications and equivalents, as will be appreciated by those of skill in the art. Those of ordinary skill in the art having access to the teaching herein will recognize additional implementations, modifications, and embodiments, as well as other fields of use, which are within the scope of the present disclosure as described herein.

The present teaching relates to radiator heaters and, in particular, baseboard radiator heaters. More particularly the present teaching relates to baseboard radiator covers that are resistant to moisture, urine, and other environmental conditions that cause discoloration of the finish and rust. For example, baseboard radiator heaters are commonly used in bathrooms and kitchens where they are often exposed to moisture and sometimes directly exposed to water and other liquids that cause oxidation on the surface of the radiator heater cover. Baseboard radiator heaters located near toilets are notorious for discoloration, which is caused by oxidation and rusting from direct exposure to splashing water and urine. Urine, in particular, rapidly rusts and corrodes prior art baseboard radiators. When conventional prior art radiators are exposed to moisture and urine they oxidize resulting in discoloration and rust over time.

Baseboard radiator heater covers that mount over baseboard radiator heaters have been used to protect and/or cover damaged radiator surfaces. For example, U.S. Pat. No. 5,884,690 describes a cover apparatus that is designed to be placed over a baseboard radiator heater. The cover apparatus is formed of non-conductive thermoplastic materials and includes an offset portion with a series of spaced apertures for convention. This heater cover apparatus does not provide for good convection or good conduction heat transfer and, therefore, is undesirable for many consumers.

In addition, the present teaching relates to baseboard radiator heater covers which protect and/or cover damaged baseboard radiator heater surfaces, but that also provide for significant convection heat transfer from the baseboard radiator heater into the room while providing insulation to hot water pipes adjacent to the cover that improves overall efficiency. The baseboard radiator heater cover according to the present teaching can provide convection heat transfer into the room along the entire baseboard radiator heater or in only predetermined areas of the baseboard radiator heater. In some embodiments, the baseboard radiator heater cover also provides for conduction heat transfer into the room in addition to convection heat transfer into the room. Also, in some embodiments, the baseboard radiator heater cover provides enough insulation in predetermined areas to reduce radiation losses in these predetermined areas so that heated water within the hydronic heating system flows through the baseboard with less energy loss, thereby increasing the overall efficiency of the system. In various embodiments, convection heat transfer is provided by forming a plurality of apertures or slits through the radiator heater cover in predetermined areas. The plurality of apertures or slits can be any shape and can be uniformly or non-uniformly positioned in the baseboard radiator heater cover.

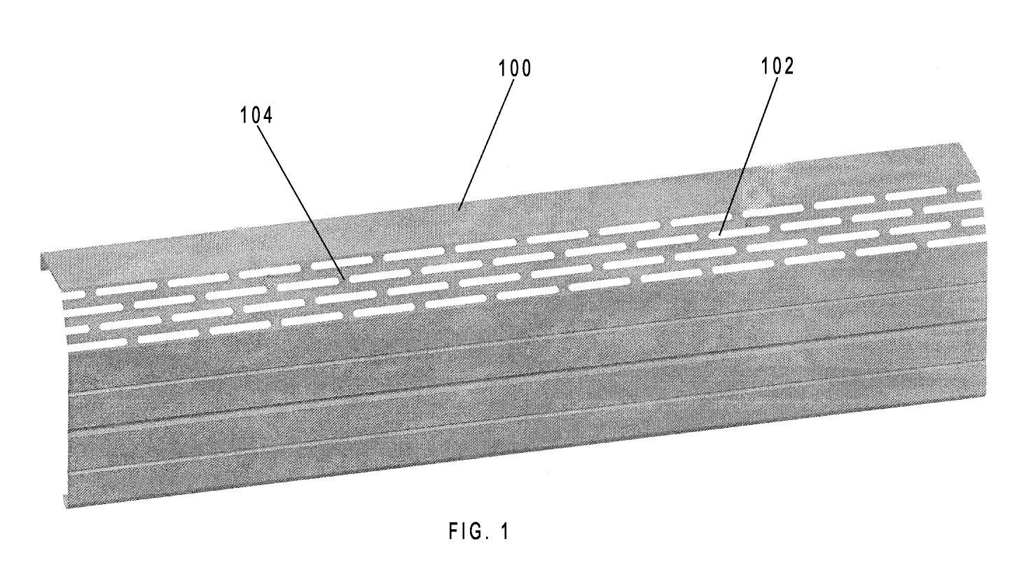

FIG. 1 illustrates a perspective view of the front panel of a radiator heater cover 100 according to the present teaching that provides convective heat transfer from a radiator heater into a room. The radiator heater cover 100 shown in FIG. 1 is a baseboard radiator heater cover that is designed to fit over existing radiator heater baseboards. However, one skilled in the art will appreciate that although the present teaching is described in connection with baseboard radiator heater covers, the radiator heater cover according to the present teaching can cover any type of radiator heater including any type of free standing radiator heater. In addition, one skilled in the art will appreciate that the radiator heater cover according to the present teaching can be positioned over substantially all of the radiator heater surface or any part of the radiator heater surface depending upon the desired heat transfer and visual aesthetics.

Radiator heater covers according to some embodiments of the present teaching are formed of a plastic material that has the desired mechanical and thermal conductivity properties. Numerous types of plastic materials can be used. For example, radiator heater covers according to the present teaching can be formed of thermoplastic material including at least one of liquid crystalline polymer, polyethylene, polyamide, polycarbonate, polypropylene, polyphenylene sulfide, thermoplastic elastomer, copolyester elastomer, polystyrene, polyvinyl chloride, polytetraflouroethylene, and poly (methyl methacrylate). One skilled in the art will appreciate that numerous types of plastic materials having the desired mechanical and thermal properties can also be used. These plastic materials can be embedded with a colorant to change the color of the baseboard radiator heater cover to any color desired by the consumer. The radiator heater cover may be formed by various inexpensive plastic molding fabrication techniques that are well known in the industry.

Also, in various embodiments, the baseboard radiator heater cover is formed of a conductive polymer material that provides significant heat transfer through conduction in addition to convection heat transfer. Numerous types of conductive polymer materials that are known in the art can be used. For example, the conductive polymer can be formed of a thermoplastic material that is embedded with carbon steel. The thermoplastic material can also be embedded with numerous other materials, such as boron nitride, and/or ceramic materials. Known thermally conductive plastics will conduct thermal energy in a range from about 0.01 W/mK to 100 W/mK. Such thermally conductive plastics are currently commercially available from Cool Polymers, Inc, of Warwick R.I., and sold under the trade name CoolPoly.

The thermal conductivity of conductive plastics can be on order of 500 times greater than the thermal conductivity of conventional plastics. The optimal level of thermal conductivity for baseboard radiator heater covers depends on the thermal energy applied to the cover, size of the radiator and the particular desired convection conditions. It is sometimes desirable to use conductive polymers with the highest possible thermal conductivity, but there are many applications where a particular thermal conductivity is desired to provide a desired heat transfer that minimizes radiation heat losses in the hydronic system.

Conductive polymers are well suited for baseboard radiator heater covers because they provide conductive heat transfer and they will not rust, dent, or flake. In addition, conductive polymers can also be embedded with colorant to change the color of the baseboard radiator heater cover to any color desired by the consumer. Such radiator heater covers are relatively inexpensive, easy to manufacture, and have good visual aesthetics.

In various embodiment of the present teaching, the radiator heater cover 100 can be formed of numerous types of material including various metals and insulating materials, such as polymers and plastics, and any combination thereof. That is, the radiator heater cover can be formed of a plurality of different materials that provide the desired mechanical properties, thermal conductivity properties, and visual aesthetics. In some embodiments, the radiator heater covers according to the present teachings are formed of at least some conductive materials, which provide conductive heat transfer. In other embodiments, the radiator heater covers according to the present teachings are formed of at least some insulating materials that do not provide significant conductive heat transfer, but that reduce radiation heat loss in the hydronic system. In yet other embodiments, the radiator heater covers according to the present teachings are formed of a combination of conductive materials that provide conductive heat transfer in some areas and insulating materials that reduce radiation losses in other areas.

In some embodiments, at least a portion of the radiator heater cover 100 includes a plurality of apertures 102 that allow convective heat transfer from the radiator heater into the room. In one particular embodiment that is shown in FIG. 1, each of the plurality of apertures is substantially rectangular in shape. In various other embodiments, the plurality of apertures can be any shape including oval and circular. In the embodiment shown in FIG. 1, the portion of the radiator heater cover 100 including the plurality of rectangular apertures 102 is positioned in the top portion 104 of the radiator heater cover 100. The ratio of the area of the portion of the radiator heater cover that includes the plurality of rectangular apertures 102 to the area of the solid portion is chosen to meet various design goals such as heat transfer and visual aesthetics. The portion of the radiator heater cover 100 including the plurality of rectangular apertures 102 can be formed of the same material or can be formed of a material that is different than the material forming the other sections of the radiator heater cover 100 depending upon the desired conductive heat transfer and the desired visual aesthetics.

The fill factor of the plurality of rectangular apertures 102 is chosen to provide a high degree of convective heat transfer while still sufficiently covering and protecting the underlying radiator to prevent or to reduce discoloration and rusting and also to maintain good visual aesthetics. The fill factor of the plurality of rectangular apertures 102 can also be chosen to provide at least some conductive heat transfer. The fill factor is defined herein as the ratio of open area defined by the plurality of apertures 102 to solid area in between the apertures in the area containing the plurality of apertures (not including completely covered areas). The plurality of rectangular apertures 102 can also be formed in various patterns that include solid sections between groups of rectangular aperture. The rectangular apertures 102 can all have the same dimensions or some rectangular apertures can have different dimensions. One skilled in the art will appreciate that any shaped aperture in any pattern can be used.

Similarly, the ratio of the surface area of the radiator heater cover including the plurality of rectangular apertures 102 to the surface area of the solid portion of the radiator heater cover 100 that does not include the plurality of apertures is also chosen to provide a high degree of convective heat transfer while covering and protecting the underlying radiator heater to prevent or to reduce discoloration and rusting and also to maintain good visual aesthetics. In addition, the ratio of the surface area of the radiator heater cover including the plurality of rectangular apertures 102 to the surface area of the solid portion of the radiator heater cover 100 that does not include the plurality of apertures can be chosen to provide the desired insulating properties that reduce radiant heat losses in the hydronic system.

In some embodiments, the cover is formed in a shape that provides space to allow air flow into the underling radiator heater to enhance convective heating into the room. Also, in some embodiments, the radiator heater cover is positioned relative to the radiator to improve convective heat transfer. That is, the radiator heater cover can be positioned at a predetermined distance away from the surface of the radiator heater that improves convective heat transfer. Also, the radiator heater cover can be positioned at a predetermined angle relative to the surface of the radiator heater that improves convective heat transfer. In one embodiment, the radiator heater cover according to the present invention is dimensioned and positioned relative to the underlying radiator heater to allow forced air from a fan or other device to improve the convective heat transfer.

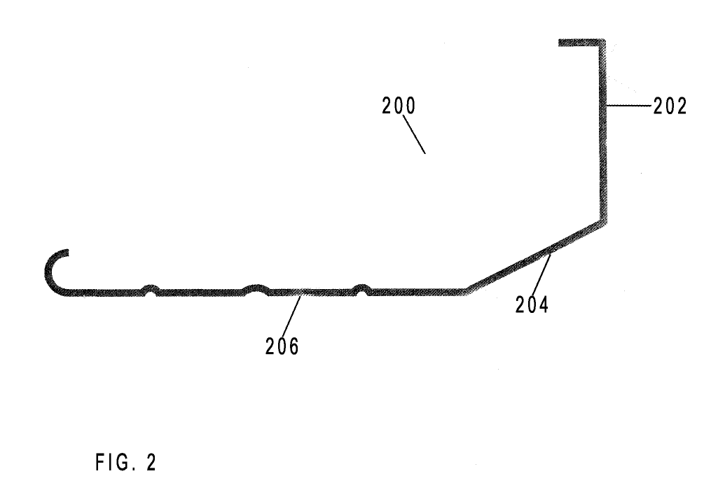

FIG. 2 illustrates a side view of a radiator heater cover 200 according to the present teaching that provides convective heat transfer from a radiator heater into a room. The side view of the radiator heater cover 200 shows a side flap 202 that can be formed at various angles depending on the radiator heater design and the desired heat transfer characteristics. In addition, the side view of the radiator heater cover 200 shows an angled portion 204 that connects the side flap 202 to the front panel 206 of the radiator heater cover 200. In some embodiments, the plurality of apertures is located only on the angled portion of the radiator heater cover 200. In other embodiments, at least some of the plurality of apertures is located on the upper section of the front panel 206 as shown in FIG. 1.

There are certain geometries of the radiator heater cover 200 that improve convection heat transfer by allowing heated air to escape from within the confinement of the baseboard cover at a relative high velocity so that the heated air travels a greater distance into the room while still maintaining heat losses in the hydronic system at an acceptable level. For radiator heater covers where the plurality of apertures is located in the angled portion 204, one such geometry that improves convection heat transfer while maintaining heat losses in the hydronic system at an acceptable level is when the ratio of the area of the front panel 206 to the sum of the areas of the angled portion and the side flap portion 202 is in the range of 0.33 to 2.25.

Some radiator heater covers according to the present teaching have shapes that are different from the shape shown in FIG. 2. In these radiator heater covers, one such geometry that improves convection heat transfer while maintaining heat losses in the hydronic system at an acceptable level is when the ratio of the area of the front panel 206 to the sum of the remaining areas is in the range of 0.4 to 6.0. Another geometry that improves convection heat transfer while maintaining heat losses in the hydronic system at an acceptable level is when the ratio of the area of the front panel 206 to the sum of the remaining areas is greater than 2.0, and the plurality of apertures is located in the upper half of the front panel 206 as shown in FIG. 1.

Thus, the radiator heater cover according to the present invention provides improved convection heat transfer into the room while maintaining insulation properties. The improved convection will allow for heated air to escape from within the confinement of the baseboard cover at a relatively high velocity, thereby providing greater heat transfer into the room at further distances from the radiator heater compared with other radiator heater covers. In addition, the improved insulating properties of the baseboard radiator heater cover allow for heated water within the hydronic heating system to travel through the baseboard with less energy loss.

### Equivalents

While the Applicants' teaching are described in conjunction with various embodiments, it is not intended that the Applicants' teaching be limited to such embodiments. On the contrary, the Applicants' teaching encompass various alternatives, modifications, and equivalents, as will be appreciated by those of skill in the art, which may be made therein without departing from the spirit and scope of the teaching.

1-25. (canceled)

26. A method of covering an existing radiator heater comprising hot water pipes, the method comprising:
a) forming a cover from a thermoplastic material in a shape comprising a front panel, a side flap formed at an angle relative to the front panel, and an angled portion, the angled portion positioned so that the angled portion connects the side flap to the front panel of the cover such that the angled portion forms an obtuse angle with the side flap, wherein a ratio of the area of the front panel to the sum of the areas of the angled portion and the side flap portion is in a range of 0.33 to 2.25 so that the cover provides a desired amount of insulation and convective heat transfer away from the cover;
b) forming a plurality of apertures in the angled portion of the cover that provide the desired amount of convective heat transfer away from the cover; and
c) mounting the cover over the existing radiator heater comprising hot water pipes such that the cover is proximate to a surface of the existing radiator heater and adjacent to the hot water pipes, wherein the cover provides the desired amount of insulation to the hot water pipes and heat transfer away from the hot water pipes.

27. The method of covering an existing radiator heater of claim 26 wherein the mounting the cover over the existing radiator heater comprising mounting the cover over a baseboard radiator.

28. The method of covering over an existing radiator heater of claim 26 wherein the mounting the cover over the existing radiator heater comprises mounting the cover over a free standing radiator.

29. The method of covering an existing radiator heater of claim 26 wherein the mounting the cover over the existing radiator heater comprises mounting the cover over the existing radiator heater such that the cover is positioned over substantially all of the surface of the existing radiator heater.

30. The method of covering an existing radiator heater of claim 26 wherein the mounting the cover over the existing radiator heater comprises mounting the cover over the existing radiator heater such that the cover is positioned over a portion of the surface of the existing radiator heater.

31. The method of covering an existing radiator heater of claim 26 wherein the forming the cover from a thermoplastic material comprises forming the cover from thermoplastic material comprising at least some conductive materials that provides conductive heat transfer from some areas of the existing radiator.

32. The method of covering an existing radiator heater of claim 26 wherein the forming the plurality of apertures in the angled portion of the cover comprises forming slit apertures.

33. The method of covering an existing radiator heater of claim 26 wherein the forming the plurality of apertures in the angled portion of the cover comprises forming rectangular apertures.

34. The method of covering an existing radiator heater of claim 26 wherein the forming the plurality of apertures in the angled portion of the cover comprises forming oval apertures.

35. The method of covering an existing radiator heater of claim 26 wherein the forming the plurality of apertures in the angled portion of the cover comprises forming circular apertures.

36. The method of covering an existing radiator heater of claim 26 wherein the forming the cover from the thermoplastic material comprises forming the cover from a thermoplastic material comprises a plastic polymer including at least one of liquid crystalline polymer, polyethylene, polyamide, polycarbonate, polypropylene, polyphenylene sulfide, thermoplastic elastomer, copolyester elastomer, polystyrene, polyvinyl chloride, polytetraflouroethylene, and poly (methyl methacrylate).

37. The method of covering an existing radiator heater of claim 26 wherein the forming the cover from the thermoplastic material comprises forming the cover from a thermoplastic material by at least one of injection molding, extrusion molding, or thermoform-molding of the thermoplastic material.

38. The method of covering an existing radiator heater of claim 26 wherein the forming the cover from the thermoplastic material comprises forming the cover from a thermoplastic material infused with a colorant.
